(19) United States
(12) Patent Application Publication
(10) Pub. No.: US 2003/0073578 A1
(43) Pub. Date: Apr. 17, 2003

(54) Method and apparatus for combating fungi in plants maintained in a closed nutrition system, especially a greenhouse

(76) Inventors: Werner Buehre, Friedland (DE); Aksel De Lasson, Braband (DK); Orla Lund Jensen, Mundelstrup (DK)

Correspondence Address: CROWELL & MORING LLP, INTELLECTUAL PROPERTY GROUP, P.O. BOX 14300, WASHINGTON, DC, 20044-4300, US

(21) Appl. No.: 10/252,006

(22) Filed: Sep. 23, 2002

Related U.S. Application Data
(63) Continuation of application No. PCT/DE01/01103, filed on Mar. 22, 2001.

(30) Foreign Application Priority Data
Mar. 23, 2000 (DE) 100 14 176.5

(51) Int. Cl. A01G 9/00

(52) U.S. Cl. 504/119; 47/17

(57) ABSTRACT

A method and apparatus for combating fungi in plants (24) that are kept in a closed nutrition system, particularly plants maintained under greenhouse cultivation, by adding Cu ions to a circulating plant nutrient solution (2). The nutrient solution concentration is measured continuously by monitoring its conductivity and maintained at a constant value by controlled addition of nutrients. Free Cu ions are released into the nutrient solution by at least one electrode pair (5) composed of a Cu anode (3) and a cathode (4), disposed in the nutrient solution. The release of free Cu ions is regulated by an associated control unit (6), depending on the requirements of the system, such that the Cu ion binding threshold of the nutrient solution is exceeded, and the nutrient solution delivered to the plants has a free Cu ion concentration of 0.1 to 0.8 ppm.

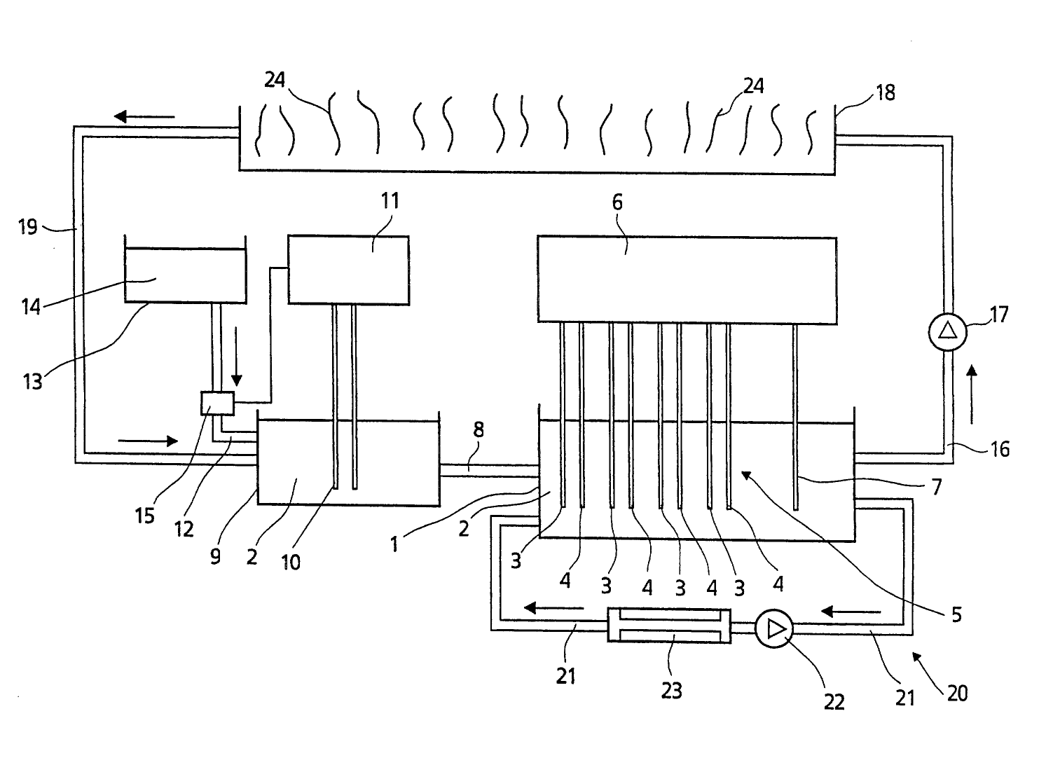

### CROSS REFERENCE TO RELATED APPLICATIONS

This application is a continuation of international patent application no. PCT/DE01/01103, filed Mar. 22, 2001, designating the United States of America, the entire disclosure of which is incorporated herein by reference. Priority is claimed based on Federal Republic of Germany patent application no. DE 100 14 176,5, filed Mar. 23, 2000.

### BACKGROUND OF THE INVENTION

The present invention relates to a method and an apparatus for combating fungi in plants that are kept in a closed nutrition system, particularly under greenhouse cultivation, by adding Cu ions to the nutrient solution, the concentration of the nutrient solution being continuously measured via its conductivity and kept at a constant value by measured addition of nutrients.

In plant cultivation in greenhouses having closed nutrition systems, problems may occur due to fungi, whose spores are spread via the circulating nutrient solution. The fungi, predominantly Pythium and Phytophthora, colonize in the region of the roots of the plants and damage them. The fungi are typically combated using fungicides.

Experiments have also already been carried out in adding copper sulfate to the nutrient solution, since copper is known as a very effective agent against fungi spores. However, difficulties have been encountered in reliably releasing Cu ions into the nutrient solution in a very low concentration, as is necessary for destroying the spores of the harmful fungi. When copper sulfate is added, it frequently occurrs that the threshold at which the Cu ions are released in a concentration which is toxic for humans, plants, and animals is suddenly exceeded. It has not been possible to reliably achieve the required concentration of 0.2 to 0.3 ppm of free Cu ions in the nutrient solution.

### SUMMARY OF THE INVENTION

It is an object of the present invention to provide an improved method of inactivating fungi spores in a closed nutrition system.

A further object of the invention is to provide a method which is capable of releasing controlled low amounts of copper ions into a nutrient solution of a closed nutrition system.

Yet another object of the invention is to provide a method of dispensing copper ions in a metered way in a low concentration sufficient to inactivate fungi spores in a closed nutrition system.

It is also an object of the invention to provide an apparatus for carrying out the method of the invention.

These and other objects are achieved in accordance with the present invention by providing a method for combating fungi in plants kept in a closed plant nutrition system by adding Cu ions to a plant nutrient solution delivered to the plants, the method comprising continuously measuring the nutrient solution concentration via its conductivity and maintaining a constant nutrient concentration by controlled addition of nutrients to the nutrient solution in response to measured nutrient concentration values; releasing free Cu ions into the nutrient solution via an electrode pair comprised of a Cu anode and a cathode arranged in the nutrient solution, and adjusting the release of free Cu ions depending on requirements of the plant nutrition system via a control unit such that Cu is present in the nutrient solution in excess of the Cu ion binding threshold and free Cu ions are present in a concentration of 0.1 to 0.8 ppm in nutrient solution delivered to the plants.

In accordance with a further aspect of the invention, the objects are achieved by providing an apparatus for combating fungi in plants kept in a closed nutrition system, the apparatus comprising a nutrient tank from which nutrient solution is conveyed in a circulating manner via a pipeline system to plant tables; a sensor positioned in the nutrient tank for continuously measuring the concentration of the nutrient solution via its electrical conductivity and maintaining a constant nutrient concentration by metered addition of nutrients from a storage reservoir; at least one electrode pair comprising a Cu anode and a cathode arranged in the nutrient solution for electrolytically releasing Cu ions from the anode into the nutrient solution; and a control unit for controlling the electrode pair to adjust the release of free Cu ions from the Cu anode such that Cu is present in the nutrient solution in excess of the Cu ion binding threshold and free Cu ions are present in a concentration of 0.1 to 0.8 ppm in nutrient solution delivered to the plants.

Preferred embodiments of the invention are described in detail hereinafter.

Because free Cu ions are released into the nutrient solution via an electrode pair comprised of a Cu anode and a cathode, which is arranged in the nutrient solution, the release of free Cu ions can be adjusted to meet the requirements of the system via an associated control unit, the binding threshold of the Cu ions is exceeded in the nutrient solution, and free Cu ions are present in a concentration of 0.1 to 0.8 ppm in the nutrient solution which is delivered to the plants. The control unit associated with the electrode pair allows the voltage and/or the current strength to be adjusted so that the specified value for the concentration of the Cu ions in the nutrient solution is reliably maintained.

Since Cu ions must be released in a large quantity into the nutrient solution to overcome the binding threshold of the Cu ions, it is necessary to apply a high voltage to the electrode pair, the preparation and, especially, control of which makes an unreasonably high technical outlay necessary in practice. Therefore, according to a preferred embodiment of the present invention, the free Cu ions are released into the nutrient solution via Cu anodes and cathodes of multiple electrode pairs arranged in a cascade circuit. In this case, the action of the electrode pairs is cumulative, with the effect that, for example, a lower voltage of 24 Volts may be used.

Using the method of the present invention, it is possible to establish and reliably maintain a concentration of free Cu ions of 0.2 to 0.3 ppm in the nutrient solution. This is an optimum value which is suitable for inactivating and/or poisoning fungi spores, without, however, damaging the plants. In addition, this value is well below a value which could lead to an enrichment of copper in the plants in a concentration harmful for humans and animals.

In a further embodiment of the present invention, the concentration of the free Cu ions is adjusted by means of an associated control unit, using an additional cathode disposed in the nutrient solution and having an electrical potential lower than that the cathode of aforementioned electrode pair.

With regard to the apparatus, an electrode pair comprised of a Cu anode and a cathode is disposed in the nutrient solution, and a control unit is provided, which can be used to adjust the release of free Cu ions in such a way that the binding threshold of the Cu ions in the nutrient solution is exceeded and free Cu ions are present in a concentration of 0.1 to 0.8 ppm in the nutrient solution which is delivered to the plants. This apparatus achieves the same advantages described above in connection with the method of the present invention.

As already noted above, multiple electrode pairs are preferably arranged in a cascade circuit. The advantages already described also result in this case.

The apparatus of the present invention additionally makes it possible to assure that free Cu ions are present in a concentration of 0.2 to 0.3 ppm in the nutrient solution which is delivered to the plants. As noted above, this is an ideal Cu ion concentration for the purposes of the invention.

It is advantageous if the cathode of the electrode pair is also made of copper and the electrodes are alternately switchable to act as a cathode or as an anode. In this way, the consumption of the electrodes is significantly reduced, since copper is alternately removed from and redeposited on each of the electrodes.

As already described, it may be advantageous if an additional cathode, having an associated control unit, which is at a lower electrical potential than the cathode of the electrode pair, is positioned in the nutrient solution.

The electrode pairs are preferably positioned in a nutrient tank. The additional electrode is also preferably positioned in the nutrient tank.

If the nutrient tank is provided with a recirculating loop, it is possible in this way to achieve continuous mixing and therefore to stabilize the Cu ion concentration in the circulating nutrient solution.

### BRIEF DESCRIPTION OF THE DRAWINGS

The invention will be described in further detail hereinafter with reference to illustrative preferred embodiments shown in the accompanying drawing figure, which is a schematic illustration of an apparatus having electrode pairs positioned in a nutrient tank in a cascade circuit.

### DETAILED DESCRIPTION OF PREFERRED EMBODIMENTS

In the drawing, 1 indicates a nutrient tank which is filled with a nutrient solution 2. Copper anodes 3 and cathodes 4 of multiple electrode pairs 5 are positioned in nutrient solution 2. The electrode pairs 5 are operatively associated with a control unit 6. Furthermore, an additional cathode 7 is positioned in nutrient solution 2, whose electrical potential may be set lower than that of cathode 4 of electrode pair 5. Control unit 6 is also associated with additional cathode 7.

Nutrient tank 1 is connected via a pipeline 8 to a mixing tank 9, in which a sensor 10 having a control unit 11 is positioned. The concentration of nutrient solution 2 is measured via its electrical conductivity by sensor 10. A nutrient concentrate 14 is supplied in a metered way from a storage tank 13 via a pipeline 12 to mixing tank 9. Control unit 11 of sensor 10 controls the supply of nutrient concentrate 14 to mixing tank 9 via a valve 15 positioned in pipeline 12.

A pipeline 16, in which a pump 17 is positioned, leads from nutrient tank 1 to a plant table 18. A return line 19 leads from plant table 18 back to mixing tank 9. Nutrient tank 1 is also provided with a recirculating loop 20, which is formed by a pipeline 21 and a feed pump 22. A treatment unit 23 for nutrient solution 2 is positioned on recirculating loop 20.

To supply plants 24 (not shown in the drawing) positioned in plant table 18, nutrient solution is conveyed from nutrient tank 1 to plant table 18 using pump 17. Nutrient solution 2 then circulates from plant table 18 via return line 19 of the nutrition system back to mixing tank 9. Nutrient solution 2 is, as a rule, supplied to plant table 18 at intervals by switching on pump 17. The release of the free Cu ions into nutrient tank 1 preferably also occurs at this time.

The concentration of nutrient solution 2 is measured via its electrical conductivity using sensor 10 in mixing tank 9. A control unit 11 associated with sensor 10 makes it possible to supply nutrient concentrate 14 in a metered way from storage tank 13 through pipeline 12 to mixing tank 9 by controlled operation of valve 15. In this way, it is possible to regulate the concentration of nutrient solution 2 in mixing tank 9. From mixing tank 9, nutrient solution 2, whose concentration is set, is conveyed via pipeline 8 to nutrient tank 1.

In nutrient tank 1, electrode pairs 8 cause an enrichment of nutrient solution 2 with free Cu ions. This is achieved in that the necessary voltage and the necessary current strength for releasing the Cu ions into nutrient solution 2 while overcoming the Cu ion binding threshold of the solution, are supplied from the control unit 6. Since the concentration of nutrient solution 2 is kept constant via sensor 10 using its control unit 11, it is also possible to maintain the current strength between anodes 3 and cathodes 4 of electrode pairs 5, which is a function of this concentration, constant at a set optimum value. In this way it is possible to achieve a constant concentration of free Cu ions of preferably 0.2 to 0.3 ppm in nutrient solution 2. Such a concentration is optimally suited for reliably killing spores, which have entered the nutrition system, in the region of the roots of plants 24 positioned in plant table 18.

The invention utilizes the advantageous effect that even low quantities of free Cu ions are suitable for reliably preventing the occurrence of fungi. On the other hand, the invention also assures that there is not such a high concentration of free Cu ions that damage to plants 24 and/or stressing of the plants with copper occurs.

Since electrode pairs 5 are arranged in a cascade circuit, it is additionally possible to set the current strength acting on the electrode pairs using a low control voltage of, for example, 24 Volts and nonetheless exceed the binding threshold of the free Cu ions in nutrient solution 2.

An additional single cathode 7 positioned in nutrient tank 1 allows fine adjustment of the concentration of the free Cu ions in nutrient solution 2, in that an electrical potential which is lower than that of cathode 4 of electrode pair 5 is also applied there via control unit 6 for actuating electrode pair 5. Additional cathode 7 has the effect that excess free Cu ions in nutrient solution 2 are trapped. The potential of cathode 7 may also be set using a low control voltage of, for example, 24 Volts, since in this case the concentration of the free Cu ions in nutrient solution 2 is merely corrected.

Using recirculating loop 20 associated with nutrient tank 1, it is possible, by switching on feed pump 22, to recirculate nutrient solution 2 located there, so that uniform distribution of the free Cu ions and the nutrients may be ensured. A treatment unit 23 positioned in recirculating loop 20 allows additional treatment of nutrient solution 2 in order to, for example, advantageously reduce the water hardness.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations falling within the scope of the appended claims and equivalents thereof.

What is claimed is:

1. A method for combating fungi in plants kept in a closed plant nutrition system by adding Cu ions to a plant nutrient solution delivered to the plants, said method comprising continuously measuring the nutrient solution concentration via its conductivity and maintaining a constant nutrient concentration by controlled addition of nutrients to the nutrient solution in response to measured nutrient concentration values; releasing free Cu ions into the nutrient solution via an electrode pair comprised of a Cu anode and a cathode arranged in the nutrient solution, and adjusting the release of free Cu ions depending on requirements of the plant nutrition system via a control unit such that Cu is present in the nutrient solution in excess of the Cu ion binding threshold, and free Cu ions are present in a concentration of 0.1 to 0.8 ppm in nutrient solution delivered to the plants.

2. A method according to claim 1, wherein said plants are kept under greenhouse cultivation.

3. A method according to claim 1, wherein the free Cu ions are released into the nutrient solution via Cu anodes and cathodes of a plurality of electrode pairs arranged in a cascade circuit.

4. A method according to claim 1, wherein the nutrient solution delivered to the plants has a free Cu ion concentration of 0.2 to 0.3 ppm.

5. A method according to claim 1, wherein the concentration of the free Cu ions is adjustable using an additional cathode disposed in the nutrient solution having an electrical potential lower than that of the cathode of said electrode pair.

6. An apparatus for combating fungi in plants kept in a closed nutrition system, said apparatus comprising:
a nutrient tank from which nutrient solution is conveyed in a circulating manner via a pipeline system to plant tables;
a sensor positioned in said nutrient tank for continuously measuring the concentration of the nutrient solution via its electrical conductivity and maintaining a constant nutrient concentration by metered addition of nutrients from a storage reservoir;
at least one electrode pair comprising a Cu anode and a cathode arranged in the nutrient solution for electrolytically releasing Cu ions from said anode into the nutrient solution; and
a control unit for controlling the electrode pair to adjust the release of free Cu ions from said Cu anode such that Cu is present in the nutrient solution in excess of the Cu ion binding threshold and free Cu ions are present in a concentration of 0.1 to 0.8 ppm in nutrient solution delivered to the plants.

7. An apparatus according to claim 6, which comprises a plurality of electrode pairs are arranged in a cascade circuit.

8. An apparatus according to claim 6, wherein said control unit is calibrated to maintain a free Cu ion concentration of 0.2 to 0.3 ppm in the nutrient solution delivered to the plant tables.

9. An apparatus according to claim 6, wherein the cathodes of the electrode pairs are also made of copper, and the electrodes are switchable to act alternately as cathodes and as anodes.

10. An apparatus according to claim 6, further comprising an additional cathode arranged in the nutrient solution, said additional cathode having an electrical potential lower than that of the cathode of said electrode pair.

11. An apparatus according to claim 6, wherein the electrode pairs disposed in a nutrient solution tank.

12. An apparatus according to claim 10, wherein said additional cathode is disposed in a nutrient solution tank.

13. An apparatus according to claim 11, wherein the nutrient solution tank is provided with a recirculating loop.
